(19) United States
(12) Patent Application Publication
(10) Pub. No.: US 2007/0080118 A1
(43) Pub. Date: Apr. 12, 2007

(54) Filter assembly

(75) Inventor: Kurt M. Lindsley, Madison, WI (US)

Correspondence Address: MICHAEL BEST & FRIEDRICH, LLP, 100 E WISCONSIN AVENUE, MILWAUKEE, WI, 53202, US

(73) Assignee: Municipal Filtration Company, LLC, Madison, WI (US)

(21) Appl. No.: 11/211,411

(22) Filed: Aug. 25, 2005

(51) Int. Cl. B01D 29/62; B01D 29/05; B01D 29/52

(52) U.S. Cl. 210/791; 210/411; 210/333.01

(57) ABSTRACT

A wastewater filter assembly comprising a cloth media filter (e.g., a cloth membrane supported by a support cage) having an influent side and an effluent side, an influent valve for controlling flow of influent to the influent side of the filter, a main reservoir (e.g., a tank) in fluid communication with the effluent side of the filter and adapted to hold effluent exiting the filter, and a backwash valve for controlling flow of backwash fluid from the filter. The main reservoir is positioned to hold effluent at a level that is above at least a portion of the filter so that backwashing of the filter can be accomplished using differential head pressure. The assembly can be made of a series of filter cells coupled to each other to form at least part of the filter assembly. Each filter cell is modular and comprises a filter, an influent valve for controlling flow of influent to the influent side of the filter, and a portion of a main reservoir in fluid communication with the effluent side of the filter and adapted to hold effluent exiting the filter. This modular design facilitates expansion of the capacity of the system. Preferably, each filter cell further includes a backwash valve for controlling flow of backwash fluid from the filter.

### FIELD OF THE INVENTION

The present invention relates to the field of fluid filtration, and particularly to filtering wastewater.

### BACKGROUND OF THE INVENTION

Before wastewater can be passed to rivers, lakes, or other waterways, suspended solids within the water must be removed. An existing method of filtering suspended solids from wastewater uses a cloth media filter of woven polyester. The cloth media filter is typically attached to a supporting framework to form a media panel, and typically multiple media panels are utilized.

While filtering the wastewater, the fluid flows through the media from an inflow or influent side of the media to an outflow or effluent side of the media. Eventually, the influent side of the media becomes clogged with the material that is being filtered from the fluid. This requires the influent side of the media to be cleaned before further filtering can occur.

One known method of cleaning the influent side of the media is accomplished by rotating the media panels past a cleaning head that is in close contact with the influent side of the media panel. This method is utilized when the influent side of the media faces away from the internal framework. Using a pump, a cleaning head places a negative pressure on the media to create a vacuum that removes solids that accumulate on the influent side of the media. The media panel is rotated past the cleaning head to clean the entire panel.

In another known method, the cleaning of the influent side of the media is accomplished by a spray head that is positioned adjacent to the effluent side of the media: This method is utilized when the influent side of the media faces the internal framework. Using a pump, a pressurized fluid stream is sprayed against the effluent side of the media panel. This forces the fluid through the media, dislodging the filtered material from the influent side of the media panel, into a collection trough. The media panel is rotated past the cleaning head to clean the entire panel.

Each of these known methods of cleaning the media panel requires equipment to rotate the panels. This may include such equipment as motors, gearing, and drive systems. In addition, a pump is required to either pressurize the cleaning fluid or to create a vacuum to remove solids from the surface of the media panel. The use of a pump and equipment to rotate the media panels adds to the cost of operating and maintaining the filtration system. Also, due to the complexity and design limitations of the equipment, expanding the capacity of the filtration system can be difficult and expensive. It is common, therefore, for prior art wastewater filtration systems to be designed for a specific capacity, without the ability to easily expand.

### SUMMARY

In one aspect, the present invention provides a wastewater filter assembly that can be easily backwashed without the need for complicated cleaning equipment and instead relies on differential head pressure to clean the filters during a backwash procedure. More specifically, the wastewater assembly of this aspect of the invention comprises a cloth media filter (e.g., a series of cloth membranes supported by a series of support cages) having an influent side and an effluent side, an influent valve for controlling flow of influent to the influent side of the filter, a main reservoir (e.g., a tank) in fluid communication with the effluent side of the filter and adapted to hold effluent exiting the filter, and a backwash valve for controlling flow of backwash fluid from the filter. The main reservoir is positioned to hold effluent at a level that is above at least a portion of the filter so that backwashing of the filter can be accomplished using differential head pressure.

In one specific embodiment, the wastewater filter assembly further comprises an influent port in fluid communication with the influent side of the filter and adapted to receive a supply of influent and provide it to the influent side of the filter, and a backwash port in fluid communication with the influent side of the filter and adapted to receive backwash fluid from the filter. The influent valve is positioned between the influent port and the influent side of the filter, and the backwash valve is positioned between the backwash port and the influent side of the filter. Preferably, the assembly also includes an influent reservoir (e.g., an influent trough) in fluid communication with the influent side of the filter, wherein the influent valve is positioned between the influent reservoir and the influent side of the filter. Also, the assembly preferably includes an intermediate reservoir (e.g., a channel) positioned between the influent valve and the influent side of the filter and also position between the backwash valve and the influent side of the filter.

In another aspect, the present invention also provides a method of operating a wastewater filter assembly, such as the one described above. The method comprises passing influent from an influent side of the filter to the effluent side of the filter to produce effluent, positioning the effluent in the main reservoir at a level above at least a portion of the filter, blocking the passage of influent from the influent side of the filter to the effluent side of the filter to create a reverse head pressure, reversing flow from the effluent side of the filter to the influent side of the filter using the reverse head pressure to produce backwash, and removing the backwash from the assembly.

Using the preferred assembly described above, passing influent from an influent side of the filter to the effluent side of the filter includes opening the influent valve, and reversing the flow from the effluent side of the filter to the influent side of the filter includes opening the backwash valve. When it comes time to replace the filter media, the method includes closing the influent valve, closing the backwash valve, and replacing the filter media.

In yet another aspect, the present invention provides a wastewater filter assembly comprising a series of filter cells coupled to each other to form at least part of the filter assembly. Each filter cell is modular and comprises a filter having an influent side and an effluent side, an influent valve for controlling flow of influent to the influent side of the filter, a portion of a main reservoir in fluid communication with the effluent side of the filter and adapted to hold effluent exiting the filter (the portion of the main reservoir cooperates with other portions to create the main reservoir). Preferably, the main reservoir is positioned to hold effluent at a level that is above at least a portion of the filter, and each filter cell further comprises a backwash valve for controlling flow of backwash fluid from the filter.

In one specific embodiment, each filter cell further comprises an influent port in fluid communication with the influent side of the filter and adapted to receive a supply of influent and provide it to the influent side of the filter, and a backwash port in fluid communication with the influent side of the filter and adapted to receive backwash fluid from the filter. The influent valve is positioned between the influent port and the influent side of the filter, and the backwash valve is positioned between the backwash port and the influent side of the filter. Preferably, each filter cell further comprises a portion of an intermediate reservoir positioned between the influent valve and the influent side of the filter and also position between the backwash valve and the influent side of the filter. In addition, each filter cell can be provided with a portion of an influent reservoir in fluid communication with the influent side of the filter. The above-described modular filter assembly facilitates expansion of the assembly capacity by the addition of more filter cells.

Other aspects of the invention will become apparent by consideration of the detailed description and accompanying drawings.

### BRIEF DESCRIPTION OF THE DRAWINGS

FIG. 1 is a perspective view of a filter assembly embodying the present invention.

FIG. 2 is a plan view of the filter assembly of FIG. 1.

FIG. 3 is a section view taken along line 3-3 of FIG. 1.

FIG. 4 is an exploded perspective view of the filter assembly of FIG. 1 showing the addition of a filter cell to expand the capacity of the system.

FIG. 5 is a section view taken along line 5-5 of FIG. 1 showing the assembly in a filtering mode.

FIG. 6 is the section view of FIG. 5 showing the assembly in a backwashing mode.

FIG. 7 is an exploded perspective view of the filter panel shown in FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

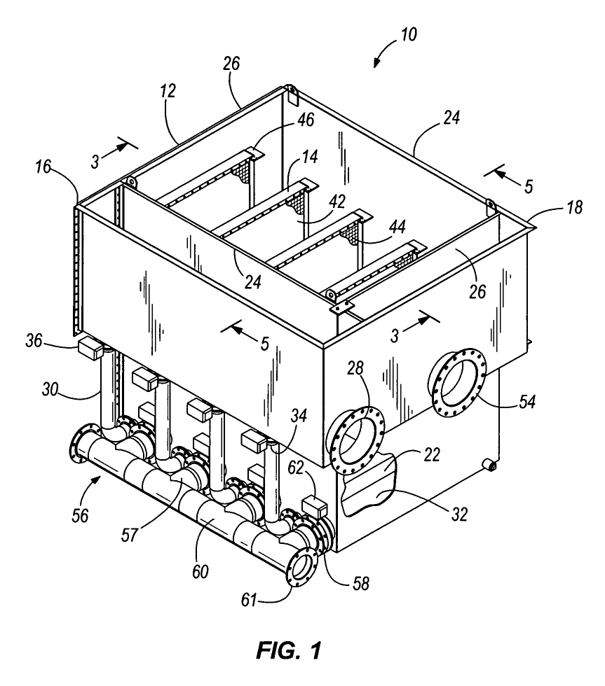

Referring to FIG. 1, the illustrated filter assembly 10 includes a tank 12 that houses a series of filter panels 14. An influent trough 16 is positioned on a side of the tank, and an effluent trough 18 is positioned on another side of the tank.

The tank 12 includes a base plate 22 that is secured to two side plates 24 and two end plates 26 to form a container to house the filter panels 14. The plates of the tank are secured to each other using flange connections. It should be understood, however, the tank can be formed in any suitable manner, such as by welding. The tank can be formed from any suitable material, such as 304 stainless steel, painted steel, concrete, fiber reinforced plastic (FRP), acrylonitrile butadiene styrene (ABS) plastic, polyvinyl chloride (PVC) plastic or any combination thereof.

The influent trough 16 includes an influent port 28 for fluid communication between the influent trough 16 and an influent supply conduit (not shown). At the base of the influent trough are a series of influent pipes 30 providing fluid communication between the influent trough and a series of corresponding lower channels 32. The influent trough can be formed from any suitable material, such as 304 stainless steel, painted steel, concrete, fiber reinforced plastic (FRP), acrylonitrile butadiene styrene (ABS) plastic, polyvinyl chloride (PVC) plastic or any combination thereof.

Each influent pipe 30 includes an influent valve 34 that controls the flow to the lower channels 32. The influent valve is movable between an open position and a close position to provide selective fluid communication between the influent trough 16 and a corresponding lower channel 32. The influent valve may comprise any suitable valve, such as a butterfly, ball, gate or globe valve. An actuator 36 is used to actuate the influent valve 34. Any suitable actuator can be used, such as pneumatic, electronic, or manual, for operating the influent valve.

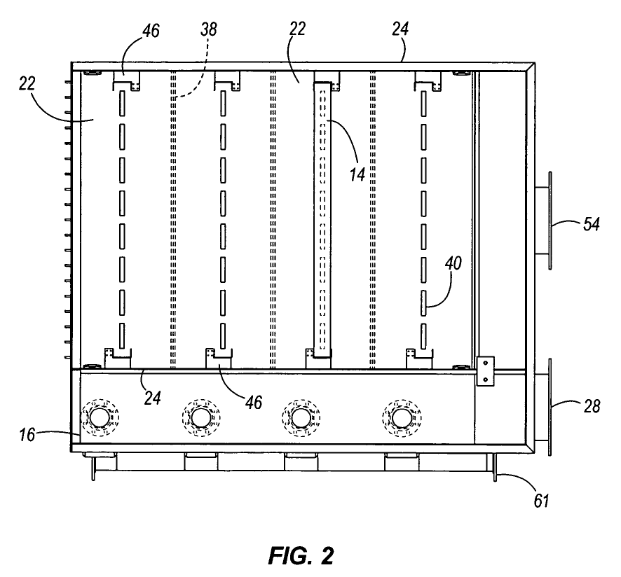

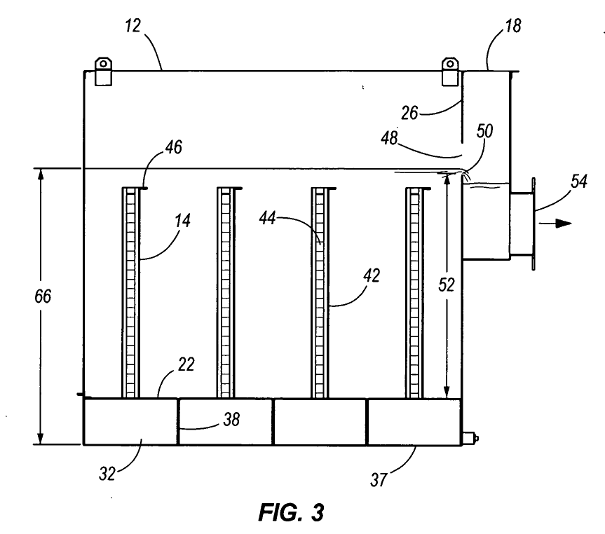

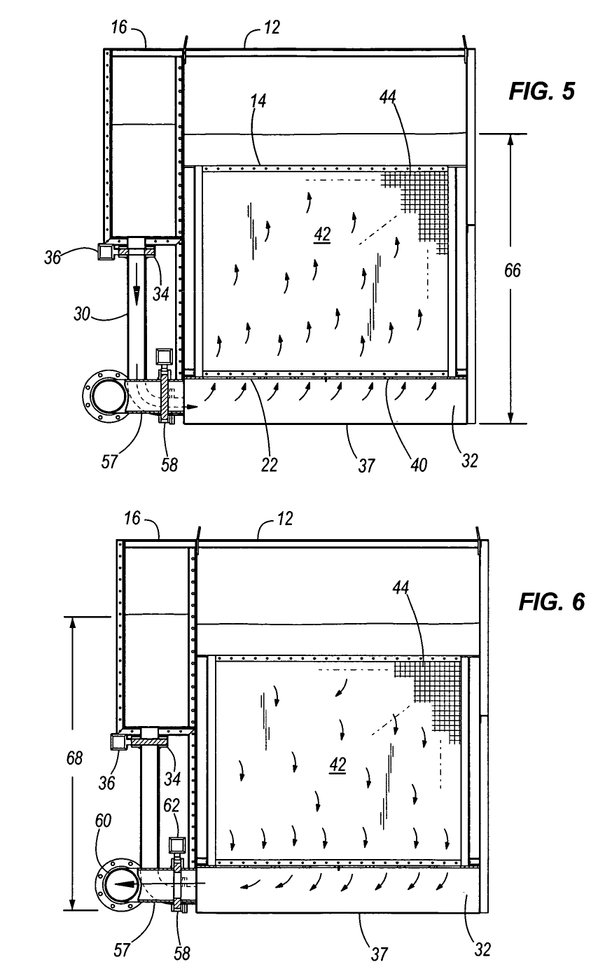

Referring to FIGS. 3 and 5, the lower channels 32 include a bottom plate 37 and side walls 38 to provide a fluid tight seal between adjacent channels. The base plate 22 of the tank 12 defines the top of the channels 32. A series of orifices 40 (see FIG. 2) on the base plate 22 provide fluid communication between each channel and a corresponding filter panel 14.

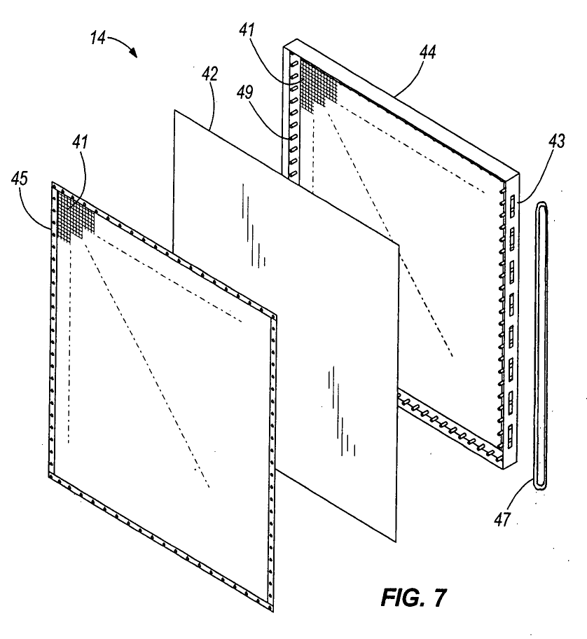

Referring to FIG. 7, each filter panel 14 includes two sheets of filter media 42 supported on an interior surface by an inner cage 44, and each sheet being supported on an exterior surface by a similar outer cage 45 (only one sheet of filter media 42 and one outer cage 45 is shown in FIG. 7, the other sheet of filter media 42 and the other outer cage 45 being attached to the backside of the inner cage 44). To support the filter media, the inner and outer cages include a grid work 41 having large openings. The illustrated filter media 42 is a cloth media filter. The cloth media filter includes filters formed from pile or woven materials, such as cotton, nylon, polyester, wire, polymer, or other suitable materials. Furthermore, an additional filter (not shown) can be placed at locations throughout the filter assembly 10, such as at the influent port 28 or in the influent pipe 30 to pre-filter large particles from the wastewater. The inner cage is coupled to both outer cages using threaded fasteners 49, but any suitable technique could be used (such as clamping, bonding, riveting, molding, etc.). The inner cage 44 includes a series of openings 43 designed to mate with the orifices 40 to provide a sealed pathway between each channel and the interior (influent side) of the corresponding filter panel 14. A gasket 47 is placed between the top surface of the base plate 22 and the bottom surface of the filter panels 14, inhibiting unfiltered wastewater from by-passing the filter panel.

A series of brackets 46 are coupled to the side plate 24 to support and allow removal of the filter panels 14 (FIG. 2). The brackets may be formed from any suitable support, such as a ‘C’ channel. Each filter panel 14 spans the distance between both side plates 24, as shown in FIG. 2. A clamp, such as a toggle clamp sold by Destaco, or other method may be used to hold the filter panel 14 firmly in position with the ability to be released for removal of the filter panel.

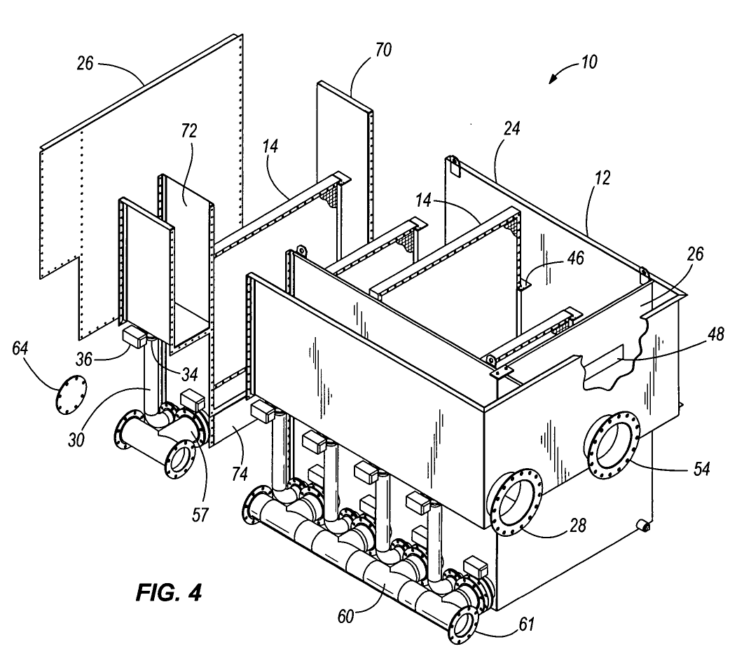

Referring to FIGS. 3 and 4, an effluent opening 48 in the end plate 26 provides fluid communication between the tank 12 and the effluent trough 18. A weir 50 is movably coupled to the end plate 26, and placed within the opening 48 to define a weir height 52. An effluent port 54 provides fluid communication between the effluent trough 18 and an effluent conduit (not shown).

Referring to FIG. 1, the filter assembly 10 also includes a backwash piping assembly 56. The backwash piping assembly includes a backwash pipe 57 and a backwash valve 58 coupled between each lower channel 32 and a backwash manifold 60 that leads to a backwash port 61. Each backwash valve 58 is movable between an open position and a close position to provide selective fluid communication between the corresponding lower channel 32 and the backwash manifold 60. The backwash valve may comprise any suitable valve, such as a butterfly, globe, gate or ball valve. An actuator 62 is also coupled to each backwash valve 58. Any suitable actuator can be used, such as a pneumatic, electronic, or manual actuator, for operating the backwash valve.

As best seen in FIG. 4, the filter assembly 10 comprises a series of filter cells 70. Each filter cell 70 comprises an influent segment 72, an influent pipe 30 (including an influent valve 34 and actuator 36), a channel segment 74, and a filter panel 14. The filter assembly typically contains at least four filter cells to allow for adequate flow during backwashing, described later. However, based on desired capacity, additional filter cells 70 may be attached to the filter assembly 10. This is accomplished by removing the end plate 26 and a blind flange 64. The additional filter cell 70 is coupled to the side plates 24, base 22, influent trough 16, and backwash manifold 60. The end plate 26 and blind flange 64 are coupled to the additional filter cell 70. This process can be repeated to include any number of filter cells 70. It should be understood that any suitable method of coupling the additional filter cell to the filter assembly may be utilized, including a bolted flange connection or welded connection.

In operation, unfiltered wastewater enters the filter assembly 10 from the influent port 28 and passes into the influent trough 16. Either a pump or gravity may generate the head required to fill the influent trough 16 to a desired level with wastewater. When a particular filter cell is in the filtering mode, the backwash port is closed, and the influent valve 34 is in the open position to pass wastewater down from the influent, trough 16 through the influent pipe 30, and into the lower channel 32 (FIG. 5).

Using the head created by gravity, the wastewater continues to pass upwards from the lower channel 32 through the orifices 40 and into the filter panel 14 (FIG. 5). Solids in the wastewater are trapped by the filter media 42 and collect on the inner surface of the filter media. The filtered water exits the filter panel 14 and enters the tank 12.

Due to the head loss in the flow path from the influent trough 16 to the tank 12, the filtered water will fill the tank to a level 66 slightly less than that of the influent trough (FIG. 5). Filtered water exits the tank 12 through the effluent opening 48 and passes into the effluent trough 18 where it exits the filter assembly through the effluent port 54.

As solids collect on the interior surface of the filter media 42, the wastewater level in the influent trough 16 rises due to the increased head loss in the flow path from the influent trough through the filter media. The weir 50, with the weir height 52, is positioned to control the wastewater level in the influent trough 16. Increasing the weir height causes the wastewater level in the influent trough to rise, while decreasing the weir height lowers the wastewater level in the influent trough. At a designated level 68 in the influent trough or at a periodic time interval, a backwash cycle is initiated to remove the collected solids from the interior surface of the filter media 42 (FIG. 6). To initiate the backwash cycle for a particular filter cell, the influent valve 34 for that cell is placed in the close position, and the backwash valve 58 for that cell is opened.

With the backwash valve 58 open and the influent valve 34 closed, the difference in water level between the tank 12 and lower channel 32 allows filtered water from the tank to flow in reverse through the filter media 42. Solids collected on the interior surface of the filter media are washed from the surface through the lower channel 32 and into the backwash manifold 60 where they are eventually discharged through the backwash port 61. The cage 44 supports the interior surface of the filter media 42 during the backwash to prevent the filter media from collapsing inwards.

Typically, only one filter cell 70 is being backwashed while the remainder continue to filter wastewater. Once the backwash is complete for a given filter cell, that cell is returned to service and begins filtering wastewater. This is accomplished by closing the backwash valve 58 and opening the influent valve 34. After the filer cell begins filtering wastewater, a different filter cell may be backwashed using the same method previously described. It should be understood that the entire backwash process may be automated through the use of a programmable logic controller (PLC). The wastewater level 68 in the influent trough 16 may be measured by a float or ultrasonic sensor and monitored by the PLC. The PLC may be programmed to backwash each filter cell in any particular order and for any duration of time required to properly remove solids collected on the inside surface of the filter media 42. In addition, depending on the number of filter cells that comprise the filter assembly 10, more than one filter cell may be backwashed at any given time.

Eventually the filter media 42 requires replacement. The filter media can be replaced while wastewater continues to be filtered through the remaining filter cells 70. Replacement of the filter media 42 is initiated by closing the influent valve 34 and the backwash valve 58 for the corresponding filter cell 70 that requires filter media replacement. Closing the influent valve and the backwash valve isolates the lower channel 32 from influent and backwash flow. With both the influent valve 34 and the backwash valve 58 closed the filter panel 14 may be lifted upwards out of the tank 12 (FIG. 4). With the filter panel outside of the tank, the filter media 42 may be removed from the cage 44 and replaced. The filter panel is then slid back into position, guided by the brackets 46, and secured in place using a clamp or other means (FIG. 2). By opening the influent valve 34, while leaving the backwash valve 58 closed, the filter cell 70 begins to once again filter wastewater from the influent trough 16 (FIG. 5).

Thus, the invention provides, among other things, a filter assembly 10 that filters wastewater until such a time that excess solids begin to collect on the interior surface of the filter media 42. At this time, filtered water from the tank 12 can be directed to flow in reverse through the filter media 42 clearing solids collected on the interior surface. Gravity, rather than a pump, is used to create the flow of filtered water required to remove the collected solids from the interior surface of the filter media. In addition, the illustrated assembly is modular to facilitate expansion of the capacity. Various features and advantages of the invention are set forth in the following claims.

What is claimed is:

1. A wastewater filter assembly comprising:
a cloth media filter having an influent side and an effluent side, the filter being positioned to filter influent to produce effluent;
an influent valve for controlling flow of influent to the influent side of the filter;
a main reservoir in fluid communication with the effluent side of the filter and adapted to hold effluent exiting the filter, wherein the main reservoir is positioned to hold effluent at a level that is above at least a portion of the filter; and
a backwash valve for controlling flow of backwash fluid from the filter.

2. The wastewater filter assembly of claim 1, further comprising:
an influent port in fluid communication with the influent side of the filter, the influent port being adapted to receive a supply of influent and provide it to the influent side of the filter, wherein the influent valve is positioned between the influent port and the influent side of the filter; and
a backwash port in fluid communication with the influent side of the filter and adapted to receive backwash fluid from the filter, wherein the backwash valve is positioned between the backwash port and the influent side of the filter.

3. The wastewater filter assembly of claim 1, further comprising an influent reservoir in fluid communication with the influent side of the filter, wherein the influent valve is positioned between the influent reservoir and the influent side of the filter.

4. The wastewater filter assembly of claim 1, wherein the filter comprises a support cage and a cloth membrane supported by the cage.

5. The wastewater filter assembly of claim 4, wherein the support cage is positioned on an influent side of the membrane.

6. The wastewater filter assembly of claim 1, further comprising an intermediate reservoir positioned between the influent valve and the influent side of the filter and also position between the backwash valve and the influent side of the filter.

7. The wastewater filter assembly of claim 1, further comprising a series of filter cells coupled to each other to form at least part of the filter assembly, each filter cell comprising:
a cloth media filter having an influent side and an effluent side, the filter being positioned to filter influent to produce effluent; and
a portion of the main reservoir in fluid communication with the effluent side of the corresponding filter, wherein the portion of the main reservoir cooperates with other portions to create the main reservoir that is adapted to hold effluent exiting the filters.

8. The wastewater filter assembly of claim 7, wherein each filter cell further comprises:
an influent port in fluid communication with the influent side of the corresponding filter, the influent port being adapted to receive a supply of influent and provide it to the influent side of the corresponding filter;
an influent valve positioned between the corresponding influent port and the influent side of the corresponding filter; and
a backwash port in fluid communication with the influent side of the corresponding filter and adapted to receive backwash fluid from the corresponding filter, wherein the backwash valve is positioned between the corresponding backwash port and the influent side of the corresponding filter.

9. A method of operating a wastewater filter assembly having a cloth media filter and a main reservoir in fluid communication with an effluent side of the cloth media filter, the method comprising:
passing influent from an influent side of the filter to the effluent side of the filter to produce effluent;
positioning the effluent in the main reservoir at a level above at least a portion of the filter;
blocking the passage of the influent from the influent side of the filter to the effluent side of the filter to create a reverse head pressure form the effluent side of the filter to the influent side of the filter;
reversing the flow of effluent from the effluent side of the filter to the influent side of the filter using the reverse head pressure to produce backwash; and
removing the backwash form the assembly.

10. The method of claim 9, wherein the filter assembly further includes an influent valve for controlling flow of influent to the influent side of the filter, and wherein passing influent from an influent side of the filter to the effluent side of the filter includes opening the influent valve.

11. The method of claim 9, wherein the filter assembly further includes a backwash valve for controlling flow of backwash fluid from the filter, and wherein reversing the flow of effluent form the effluent side of the filter to the influent side of the filter includes opening the backwash valve.

12. The method of claim 9, wherein the filter assembly further includes an influent valve for controlling flow of influent to the influent side of the filter, and a backwash valve for controlling flow of backwash fluid from the filter, and wherein the method further comprises:
closing the influent valve;
closing the backwash valve; and
replacing the filter.

13. The method of claim 9, wherein the filter assembly further includes an intermediate reservoir in fluid communication with the influent side of the filter, and wherein passing influent from an influent side of the filter to the effluent side of the filter includes passing influent through the intermediate reservoir.

14. The method of claim 9, wherein the filter assembly further includes an intermediate reservoir in fluid communication with the influent side of the filter, and wherein reversing the flow of effluent from the effluent side of the filter to the influent side of the filter and removing the backwash from the assembly includes passing influent through the intermediate reservoir.

15. A wastewater filter assembly comprising a series of filter cells coupled to each other to form at least part of the filter assembly, each filter cell being modular and comprising:
a filter having an influent side and an effluent side, the filter being positioned to filter influent to produce effluent;
an influent valve for controlling flow of influent to the influent side of the filter; and
a portion of a main reservoir in fluid communication with the effluent side of the filter, wherein the portion of the main reservoir cooperates with other portions to create the main reservoir and adapted to hold effluent exiting the filter.

16. The wastewater filter assembly of claim 15, wherein the main reservoir is positioned to hold effluent at a level that is above at least a portion of the filter, and wherein each filter cell further comprises a backwash valve for controlling flow of backwash fluid from the filter.

17. The wastewater filter assembly of claim 16, wherein each filter cell further comprises:
an influent port in fluid communication with the influent side of the filter, the influent port being adapted to receive a supply of influent and provide it to the influent side of the filter, wherein the influent valve is positioned between the influent port and the influent side of the filter; and
a backwash port in fluid communication with the influent side of the filter and adapted to receive backwash fluid from the filter, wherein the backwash valve is positioned between the backwash port and the influent side of the filter.

18. The wastewater filter assembly of claim 16, wherein each filter cell further comprises a portion of an intermediate reservoir positioned between the influent valve and the influent side of the filter and also position between the backwash valve and the influent side of the filter.

19. The wastewater filter assembly of claim 15, wherein each filter cell further comprises a portion of an influent reservoir in fluid communication with the influent side of the filter.
